(19) United States
(12) Patent Application Publication
(10) Pub. No.: US 2004/0143494 A1
(43) Pub. Date: Jul. 22, 2004

(54) Method of air-miles attrition in conjunction with in-flight gaming

(75) Inventors: Timothy K. Henderson, Essex Junction, VT (US); Aharon Zeev Hed, Nashua, NH (US); Richard Pavelle, Winchester, MA (US); Sol Aisenberg, Natick, MA (US); George Freedman, Wayland, MA (US)

Correspondence Address: THE FIRM OF KARL F ROSS, 5676 RIVERDALE AVENUE, PO BOX 900, RIVERDALE (BRONX), NY, 10471-0900, US

(73) Assignee: INVENT RESOURCES, INC.

(21) Appl. No.: 10/348,918

(22) Filed: Jan. 22, 2003

(51) Int. Cl. G06F 17/60

(52) U.S. Cl. 705/14

(57) ABSTRACT

A method of processing passenger air-miles to provide attrition in accounts in which air miles tend to accumulate from numerous sources, whereby the air-miles are used as credits for wagering on gaming consoles at least in-flight and usually also at waiting facilities for such flights.

### FIELD OF THE INVENTION

The present invention relates to new methods of using air-miles generated by the airlines and the travel industry, in general, as wagering means for in-flight gaming systems.

### BACKGROUND OF THE INVENTION

Over the last few decades, to enhance customer loyalty, airlines have issued to passengers “air-miles” and bonus air-miles that correspond to the actual mileage flown or other travel services acquired. Other travel industry partners of said airlines, such as hotel chains, credit card issuers and phone companies have also issued “air-miles” to consumers. Typically, these air-miles are redeemable in the form of free airline tickets to various destinations. These air-miles have now become a serious future liability to the airlines, and there is a need to limit such a liability. Some airlines have started to introduce air-miles with limited life spans (in essence aging air-miles thus reducing the number of outstanding air-miles over time). However, customers have been accustomed to these “giveaways” and ill will could accrue to airliners if such a tactic is used excessively. There is therefore a need to limit the number of air-miles outstanding, without creating ill will within the loyal population of airlines' travelers, preferably through the attrition of such air-miles in a process that can be viewed positively by the passengers. One such attrition mechanism would allow passengers to use their respective air-miles credit as wagers in a system of airborne entertainment units that can act alternatively as gaming consoles. The fact that no monetary consideration is involved might even allow such gaming in jurisdictions where gaming is prohibited by law. Air-miles credit cannot be considered as “monetary means” since there is no fixed exchange rate at any time, between air-miles and traditional currencies. Another advantage of having a method of using air-miles as the means of wagering in in-flight gaming is providing an active alternative to passive entertainment during flight. To the best of our knowledge there is no prior art suggesting the use of air-miles as a means of accumulating winnings or losses while playing gambling games either on airlines nor on other transportation means.

In-flight entertainment is well known in the prior art, furthermore, systems designed for passenger planes allowing switching between normal entertainment and gaming has been described in the prior art as well. For instance, one such system cited in U.S. Pat. No. 5,618,232 to Martin, describes an electronic gaming device system which can be switched between an amusement mode and a gaming or gambling mode. The impetus being that it may be useful for vehicles such, as airplanes or boats which move geographically from jurisdictions where gaming is legal to jurisdictions where it is not. However, the system described by Martin provides for wagering only with special tokens or the insertion of a credit or debit card into an appropriate slot, essentially involving monetary consideration for engaging in gaming.

In order to facilitate the introduction of in-flight gaming which utilizes passengers' preexisting air-miles, or even air-miles that are due during the flight said passengers are engaged in, means are required to update such customer air-miles accounts and means that are recognizable or readable at the entertainment/gaming console. The prior art does describe such means. For instance, in U.S. Pat. No. 5,655,966 to Werdin, is described a bar-top gaming system comprising a plurality of player stations interconnected to a table server which is connected to a modem creating a system which provides players with a cash-less way of playing said gaming system. The “means” of wagering are prepaid magnetic cards and the gaming system includes a credit card magnetic strip reader. However, said system does not enable the use of air-miles as the means by which the wagering transactions are settled. Similarly, in U.S. Pat. No. 6,386,457, Sorie describes a prepaid entertainment card and methods and systems for using prepaid entertainment cards. However, these are intended for use by television programming providers to collect revenue for providing television programming to subscribers in advance of providing at least some of the programming to the subscribers and cover specifically monetary values rather than air-miles values, and as mentioned before, air-miles cannot be deemed to be equivalent to monetary means. There is therefore a need to provide means and methods for updating air-miles accrued to a customer, such means being capable of interfacing with in-flight entertainment and gaming devices to allow for additions or subtraction of such air-miles, as the outcome of such gaming may dictate.

A method of updating information on credit cards and credit card like devices was described in a co-pending application entitled “Wireless Communicating Credit Cards” (application Ser. No. 09/790,116 filed Feb. 9, 2001) co invented by two of the present inventors, and this document is hereby incorporated herein by reference. Such a device and variants thereof, as will be further detailed below, could be used as one of the embodiments for the means to update information as required, as well as possible interfacing device with the contemplated in-flight entertainment and gaming systems.

### OBJECTS OF THE INVENTION

It is the main object of the present invention to provide a method of doing business based on the exploitation of existing air-miles in customers accounts for the purpose of engaging in in-flight gaming, and thus reduce airliners overall air-miles liabilities while providing gaming entertainment to passengers.

It is another object of the present invention to provide a system in which the then accrued air-miles credit of each passenger can be communicated to the in-flight gaming system, and during the gaming process the then current air-miles balance is displayed for viewing by the passenger.

It is yet another object of the present invention to provide for updating an airline's Data Base System (DBS) at least intermittently (preferably when a plane has landed and other data are downloaded to the airliner DBS), of each passenger air-miles status.

It is a further object of the present invention to provide for a system of air-miles attrition in which all airlines, or at least groups of airlines, provide in-flight gaming systems through which said air-miles attrition can be carried out, this, independently of the source of issue of said air-miles.

### SUMMARY OF THE INVENTION

The present invention addresses the airliner company's need to reduce their inventory of air-miles credited to passengers' accounts by providing a method that will result in the attrition of said inventory. Specifically, we propose to use such air-miles during flight and as part of the entertainment package offered to passengers. Most airplanes are already equipped with individual displays on which various programs can be viewed. Such displays are controlled from a central processor on the airplane, and new programs are often loaded on said processor intermittently. The method of air-miles attrition is specifically the use of said air-miles for settling in-flight gaming outcomes. Since gaming is designed to have “the house” (namely, the airliner) to have a statistical advantage, over time, such air-miles will be used up by those participating in the in-flight gaming. This approach has a number of advantages. It will cause air-miles attrition while providing a desirable service to passengers, and such a service can probably be implemented in jurisdictions where traditional gaming is prohibited by local law.

Another embodiment of the invention relates to means by which an in-flight gaming console at the passenger seat can interface with a passenger's magnetic or electronic card to first identify said passenger and its air-miles account, and then display, as part of the gaming process the then accrued air-miles. Such means can be a disposable card having on it a magnetic strip, very similar to the format of a traditional credit card. Such a card would be issued at the ticket counter (or sent with the ticket when tickets are mailed) on which the magnetic strip has encoded on it both the passenger's ID as well as the then accumulated air-miles. Alternatively, the passenger's boarding pass, which itself has a magnetic strip can be used for that purpose as well. Yet another alternative to identify the passenger and record magnetically its accrued air-miles, as well as create the interface between the passenger and an in-flight entertainment console, is the use of the passenger's air-miles card. This card, which has the format of a traditional credit card, has on it an appropriate magnetic strip that can be used to register the desired information.

In another embodiment of the invention, for those passengers having communicating credit cards (such as described in the co-pending application Ser. No. 09/790,116 filed Feb. 9, 2001 mentioned above), simply involves making appropriate arrangements with the credit card issuer (which can be the airliner itself) to provide air-miles data via the same channels described in said application.

In yet another embodiment of the invention, the airline company may issue to its passengers its own communicating credit cards, install at strategic location within the airport appropriate transceivers, said transceivers, being interfaced to the airline's data base and operating preferably under the Bluetooth protocol (a protocol of communications for very short distances), and thus enabling the passenger to update its communicating credit card with the then current air-miles credit in his account, prior to boarding a plane.

In yet another embodiment of the invention, the means of conveying the air-miles accruals to either the passengers, or the in-flight gaming consoles are card-less and simply involve direct data communication between a central processing unit (CPU) on board the airplane that controls the gaming consoles in the cabin, and the specific airline's central database computer. When this approach is used, the passenger is expected to input a personal identification code, or any other special code provided by the airline for the specific flight through a keyboard pad on the entertainment console. To the extent that airlines already carry on data transfer from their airborne computer to their central data base upon completion of a given flight, the transfer of air-miles information can be transferred at the same time. This involves both updating air-miles information on incoming passengers for the next leg in the airplane's route, as well as downloading status of air-miles attrition or accrual from passengers departing said plane at the end of the specific flight. When no such routine data dumping occurs, then a specific transfer of data from the airborne CPU to the airliner's data base is carried out, just for updating air-miles information in the airline's central computer and the company's data base system.

Another aspect of the present invention involves arrangements made between various air carriers, all having in-flight gaming in which air-miles are used to settle gaming outcomes, as well as between such carriers and their travel industry partners, such as hotel chains, car rental companies etc. Such arrangements involve prorating of gaming outcomes between the carrier on which such gaming is conducted and the original issuer of the air-miles involved in settling such in-flight gaming.

According to an aspect of the invention the attrition of air miles awarded to a passenger or obtained form other sources than an air line, hereinafter referred to as a service or goods provider, comprises the steps of:

(a) issuing air-mile credits to passengers for embarking upon or completing air-line flights or as premiums for other activities or for purchases;

(b) maintaining for each passenger an account of accrued air-miles; and

(c) enabling a passenger having a respective account of accrued air-miles to engage in wagering upon a gaming console on a respective flight with gaming credits in the form of air-miles from the respective account and automatically in response to the wagering,

crediting winnings in terms of air-miles to the account of the passenger,

debiting losings in terms of air-miles to the account of the passenger, and

displaying additions to, subtractions from and current balances of air-miles in the account on the console.

As previously noted, normally a passenger may have a number of accounts for a variety of services or for the purchase of goods which also may provide air miles or credits or debits which can be treated in terms of air miles based upon negotiations upon the providers.

In that case, the console can provide the passenger with access to a number of accounts maintained by a plurality of providers of goods and services and the method can further comprise the steps of:

(d) automatically calculating prorating of air-mile credits and debits with respect to each of the accounts of the passenger based upon prior negotiations by the providers;

(e) enabling the passenger to draw selectively upon the passenger's accounts with the providers for the wagering upon the gaming console; and

(f) automatically crediting or debiting based upon the prorating of step (d) the selected account of the passenger with winnings or losings in step (c).

Generally a plurality of the gaming consoles are provided on each of a multiplicity of flights of an airline providing these miles as well as at a waiting facility of the traveller.

When the air miles are provided to the passenger by recording them on a card held in possession of the passenger/player, the gaming console can interact with the card and air miles recorded on the card will be debited from the account on a wagering loss.

The account can be maintained at a central station and credited and debited through wireless communication with the gaming console and communication between the card and the console or the card and the central station can also be in a wireless manner.

According to a feature of the invention the method includes the steps of accumulating data with respect to wagering activity from a multiplicity of gaming consoles on an aircraft with a central processing unit thereon and communicating information with respect to the accounts of respective passengers from the central processing unit to a central ground computer installation of the airline.

The console can be one of a plurality of gaming consoles provided on a multiplicity of aircraft and at a plurality of locations in an airport, passenger accounts are accessed through wireless communication cards issued to the respective passengers, and the cards have displays which are updated intermittently automatically or on demand by the respective passengers.

The cards can communicate via short range transceivers in the airport.

### BRIEF DESCRIPTION OF THE DRAWING

FIG. 1 is a diagram describing the various participants in the air-miles attrition system of the present invention; and

FIG. 2 is a diagram which describes in general the airborne gaming system and its interaction with ground base systems.

### DETAILED DESCRIPTION OF SOME SPECIFIC EMBODIMENTS OF THE INVENTION

The present invention will now be described more fully in detail with reference to the accompanying drawings, in which the preferred embodiments of the invention are shown. The invention, however, should not be construed as limited to the embodiments set forth herein; rather, the following description is provided to make this disclosure thorough and complete and to fully convey the scope of the invention to those skilled in the art.

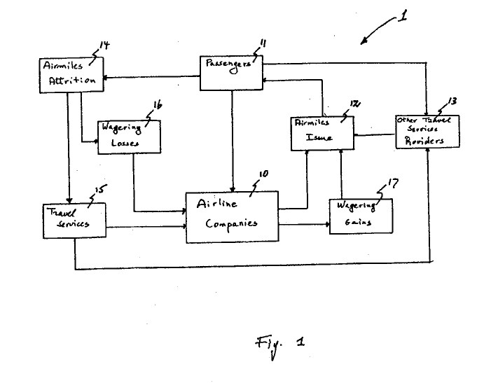

In FIG. 1 we show some of the details of the three elements involved in the method of the present invention. Specifically, the method involves transactions between an airline company, 10, and a plurality of its passengers, 11, resulting in the issuance of “air-miles”, 12. The air-miles credits are most often determined by the distances traveled by passengers on said airline. In some instances, the airliners create partnerships with other travel service providers, 13, which can issue air-miles to passengers, as well. In the prior art, the attrition of such air-miles, 14, was through passengers using various travel services, 15, either from the airline companies, 10, or from their partners, 13. This method of attrition of air-miles, has associated with it the cost of delivering the travel services (flights, hotel rooms, car rental etc.), and is thus not optimal. In the method of the present invention, a much more cost effective method of attrition of said air-miles is provided through the use of in-flight gaming. While in-flight gaming has been implemented before, by such companies as Interactive Entertainment limited and Intergame in the US, and Sky Games in the UK, they all use one form or another of monetary payment, mostly through the use of traditional credit cards. None use accrued air-miles as the means of accruing losses or gains during in-flight gaming. However, in the method of doing business of the instant invention, wagering losses, 16, and wagering gains, 17, result in attrition and in issuance of air-miles. It should be noted that air-miles do not have a predetermined or fixed monetary value, a fixed amount of air-miles, is exchangeable for any domestic flight, another for any cross Atlantic flight, etc. independently of the fares such flights might typically bear. This lack of fixed exchange rate at any given time, makes air-miles a non monetary instrument. As is typical with gaming systems in general wagering losses are always greater than wagering gains, and thus net attrition of air-miles accrued to all passengers would occur from practicing the method of the present invention.

Specifically, the method of doing business of the present invention, resulting in attrition of accrued air-miles in passengers accounts, consists of:

a. issuing air-miles credits to a plurality of passengers, typically, issued by an airline company, in association with flights said passengers have embarked on or completed;

b. maintaining for each passenger an account of accrued air-miles;

c. providing entertainment consoles, that are gaming capable at plurality of airline seat, at least on some of the airline's flights;

d. providing means enabling each passenger to engage in wagering during flight, including means that update each gaming console, or station with the then current accrued air-miles credit in each wagering passenger's account; and

e. displaying for said passenger the then current air-miles credited to his account, including additions or subtraction to said account resulting from the most recent gaming session engaged in by said passenger, and

allowing said passengers to engage in in-flight gaming and debiting air-miles attrition or crediting air-miles additions resulting from said gaming to the passenger's air-miles account.

In some embodiments of the invention, the issuing of air-miles credits can be carried on by non airlines entities as well, under special cooperation agreements, or joint marketing agreements between the airline company in question and said non airlines entities. In the past, such agreements have been made between airline companies and other participants in the travel industry, such as hotel chains, rental car companies, long distance carriers and other providers of telecommunication services, and even major issuers of credit cards. While the issuance of such air-miles creates a major liability for the involved issuers, such issuance, does however, serve as an important marketing incentive means to enlist potential new customers for the services and goods provided by the various issuers. It should be understood, however, that attrition of air-miles so issued by non airline companies, can be carried out through in-flight gaming as long as these air-miles are credited to each passenger air-miles account.

It should also be understood that arrangements can be made between different issuers of air-miles, so as to allow uniform attrition of air-miles when passengers engage in in-flight gaming. Such arrangements are already in existence between select groups of carriers relative to other method of air-miles attrition, such as the use of air-miles in exchange of various travel related services. However, there is no reason that such arrangements not be made between all carriers relative to the method of attrition of air-miles of the present invention. Such arrangements could involve, but are not limited to, for instance, the partitioning on a pre agreed scale of the attrition of air-miles from a cross issuers, as well as the wagering gains when these apply, between the air-miles issuer and the company on whose vessel the wagering sessions are carried out. In this context, a cross issuer is a carrier, or another air-miles issuer, whose issued air-miles are undergoing attrition during in-flight gaming on another carrier, not the specific issuer of the specific air-miles used in settling the wagering session.

Thus, in some embodiments of the air-miles attrition methods of the present invention, passenger air-miles accrued with any of the issuers of said air-miles, can be used in in-flight wagering during flights on any of the participating issuers.

Similarly, while we have mentioned specifically “in-flight” wagering, one can visualize other travel service providers, such as hotel chains or cruise ships, providing entertainment means that can be easily converted to gaming console when so desired, within their own facilities, said gaming resulting in credits and debits of air-miles only.

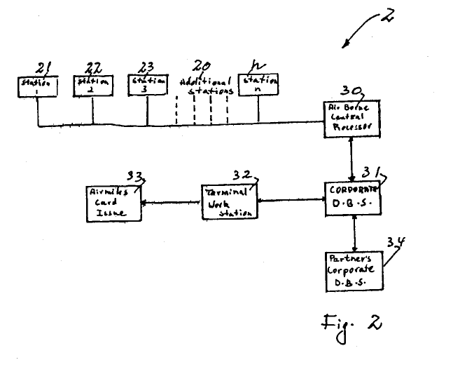

In FIG. 2 is shown a general description of a system, 2, with which the method of air-miles attrition can be practiced. It should be understood that in different embodiments of the system, different elements described in FIG. 2 may or may not be used. For instance, in some embodiments of the invention, the system contains a number of entertainment stations, 20 to “n”, that are connected to an airborne CPU, 30 (and its associated drivers and memory devices). While we have shown only four such stations in FIG. 2, it should be understood that essentially all “n” passenger seats on the airplane are each equipped with such stations. Each station is identified by its own identification number (in FIG. 2, essentially from 1 to n, corresponding to the numeral 20, 21, 22 for the stations 1 to 3 respectively, and n for station “n”).

The entertainment stations, 20 to “n” are built in such a manner that they can be converted to gaming consoles, when released to fulfil that function by an appropriate command from the airborne CPU, or, alternately, by special means, carried by the passenger, such as a magnetic card (33) issued to qualified passengers prior to flight, from a terminal work station, 32.

The terminal work station is in communication with the airline company's data bases system (DBS), 31, to assure correct recording of the accrued air-miles to each qualified passenger.

In some embodiments of the invention, the corporate DBS, 31, is put in communication with the airborne CPU, 30, prior to and after each flight, to assure correct accounting of the attrition of air-miles from each passenger, or in cases some passenger's in-flight wagering session resulted in gains, to assure recording of such gains to each passenger's air-miles account.

In embodiments of the invention involving cooperation between other entities issuing air-miles credits, either other airlines or other travel related services companies, a connection to such other corporate partners DBS, 34, is provided. There are a number of possible method of updating the information from a partner's DBS to the airline's own DBS. In most cases, companies are not inclined, for security reasons, in providing to other companies, free access and a permanent communication link to their own data base. Therefore, in such cases, intermittent exchange of information related to passengers air-miles between the airline company's DBS, 31 and its corporate partners DBS, 34, is carried out. This exchange or update of passenger's air-miles credits can be carried out on a monthly basis, a weekly basis or even a daily basis. Appropriate protocols for such exchange of information are already available and practiced between airline companies and their various corporate partners, and thus are not part of the present invention.

Returning now to the means, 33, by which each console in the airplane is readied for a wagering session. As mentioned above, one such mean is the use of an equivalent to a disposable magnetic card. The magnetic card, can be part of the existing boarding pass, that part which the passenger carries on board, and on which the passenger's seating assignment is provided. Such a boarding card is already issued by most airlines with a magnetic strip on it, the magnetic strip is used to embed information such as the flight number, the passenger identity etc, and is typically read by a magnetic reader, just prior to boarding the airplane. It is therefore quite easy to embed the additional information relative to the passenger's accrued air-miles on such boarding passes and its associated stub. The incorporation of that additional information (accrued air-miles) will not involve any additional instrumentation at the terminal work station 32. The same magnetic strip which is used to admit a passenger on the airplane, can now be used to activate the conversion of the entertainment console (20 to n) at each passenger seat on the airplane. When the boarding pass stub, and particularly, the magnetic strip on said stub, is used as means to activate the entertainment console at the passenger seat, and convert it to a wagering station, the airline may chose to enable only the console associated with the seat assigned to same passenger.

When using the boarding pass stub, as the means by which to activate an entertainment console and convert it to a wagering station for the passenger carrying stub, it is not anticipated that the console would update any information on said stub magnetically. Updates will then be communicated during the next communication between the airline's CPU and the corporate DBS. All intermittent updating would be carried out and displayed to the passenger on the playing console. When a passenger is engaged in airborne travel in which a plurality of embarkation and debarkation steps are contemplated, and boarding passes are issued for each leg of the journey, the airlines may find the use of the boarding pass magnetic strip as means of activation of the entertainment consoles and converting said consoles to wagering consoles, difficult, or at least somewhat troublesome. For instance, if two boarding passes are issued for one trip, and each boarding pass stub in the hand of the passenger has a record of all of the passenger's air-miles, it is possible for such a passenger to cause full attrition of its air-miles during wagering session on both legs of his trip, resulting in actual air-miles debit in such a passenger account. Air-miles debits are extremely difficult to settle, particularly since they have no well defined monetary values, and thus should be avoided as much as possible.

There are a number of ways to overcome the problem involved with such duplicity of records. The simplest one is to allocate to each boarding pass issued on a multiple legs trip, only a portion of the air-miles credits accrued in said passenger's account. This approach assures that said passenger never gets to the point where his in-flight gaming activities result in air-miles debit. Another approach is to limit the number of air-miles that can be subject to gaming attrition on any single boarding pass, and that that limitation be well under the normal level of air-miles credit said passenger might have.

In view of some of the limitations involved with using boarding pass stubs and their associated magnetic strips, in some embodiments of the invention, airlines may find it advantageous to issue a separate magnetic card, 33, issued typically at the terminal workstation, 32. Such a disposable magnetic card would be an entertainment console dedicated card, designed specifically to convert said console into a wagering station and be valid for a limited period, such as a period covering only the length of time the expected travel session such a passenger might be engaged in. Such a disposable card will have its own magnetic strip on which the passenger unique identification as well as his then current air-miles credit would be imprinted at the terminal work station 32. In some embodiments, such a card would be limited to be used only at the console associated with the seat assigned to the passenger, while in other embodiments, the airline may chose to enable such wagering at any console within the aircraft. Clearly, with the passenger own unique identification number embedded on the said disposable magnetic card, correct assignment of wagering debits and credits to this unique identification, and thus to the unique passenger will be enabled. Such data would then be updated and stored at the airborne CPU, 30, and in its associated memory devices, for later transfer to the airline's corporate DBS as further described below. If such a unique dedicated disposable magnetic card is selected, the playing console would update on the card itself the then current air-miles credit, and thus the same disposable card could be used on a plurality of legs in a single trip. It should be clear, therefore, that at least a segment of the magnetic strip be of the “rewritable” type magnetic strip, that would be the segment where actual accrued air-miles are updated.

Another alternative to a new card issued on every flight, would be the use of the passenger existing air-miles card, which the airlines are typically forwarding to passengers when they join their air-miles credit program. Such a card has on it a magnetic strip on which specific data associated with the passenger are encoded, including said passenger's unique identification number within the airline's data base. In one embodiment of the present invention, said air-miles card is provided with a segment of said magnetic strip which is rewritable. Thus at the terminal work station, 32, the passenger may be asked if he desires his gaming privileges, for the flight he is about to embark on, to be activated, and the activation, as well as the then current credit in his air-miles account, is imparted magnetically on that part of the magnetic strip that is rewritable.

The entertainment consoles, 20 to n, are provided with an appropriate slot containing a magnetic strip reader, and in some embodiments, a magnetic head writer as well, to allow reading data magnetically imparted on any of the various magnetic means described above. Namely, a boarding pass stub, a disposable magnetic card, or the existing air-miles cards typically issued to all members in the various air-miles club the airlines have already established. Insertion of the magnetic card into said dedicated slot causes reading of the information relating to said passenger, including his unique identification number (which differ between airlines). Once, the magnetic medium is read by the console, the CPU, 30, enables said console to act as a gaming station and the passenger can engage in his desired gaming or wagering. A variety of protocols can be used to initiate the gaming session, for instance, once the console identified the passenger through reading the data on the magnetic strip, the passenger, may first be welcomed to the gaming console, and then, his then current air-miles credit be displayed on said console. To the extent that the magnetic medium (any of the boarding pass stub, the disposable magnetic card or the airline issued permanent air-miles card, the latter two, with the rewritable magnetic section on the magnetic strip) bears information on the then current air-miles credit in that the passenger's account, that number is displayed. From time to time, there might arise a discrepancy between the air-miles credit registered on the magnetic medium and in the airborne CPU's memory. If such occurs, it is probably best to display the more current credit displayed by the customer borne magnetic medium, since the updating of the CPU, 30, may be delayed relative to information imprinted at the terminal workstation 32, this, because the terminal is in direct contact with the corporate DBS, which is assumed to have the most updated data on said passenger air-miles credits.

Another alternative to using magnetic media on card like devices, or boarding pass stubs, as the means of providing access to in-flight gaming consoles as well as identifying the passenger and obtaining his then current air-miles credit, is the use of an input (numerical only s sufficient) keyboard on the console. When such a keyboard is an integral part of the entertainment console, passengers are provided prior to each flight, or on a permanent basis, a unique identification number, which entry on said keyboard would provide access to the entertainment console and convert it to a wagering console. Using this embodiment relies on updating the airborne CPU, 30, from the corporate database, 31, prior to each flight.

One of the perceived shortcomings associated with any of the three magnetic strip types modalities of interface between the passenger and the entertainment consoles, as well as the method involving direct entry of a code (card less method) is the fact that the passenger may not a have an easy access to information as to his then current air-miles credit, prior to engaging the gaming console. To alleviate such a short coming, the airline may chose to implement a somewhat different strategy of updating and informing passengers of their air-miles credit status. In the co-pending patent application cited above (Ser. No. 09/790,116 entitled “Wireless Communicating Credit Card”), two of the co-inventors of the present invention disclosed a communicating credit card, and a system of updating such credit cards using existing wireless communication networks. Said communication credit cards (CCC), having a display and are updated intermittently (typically once a day automatically, by the issuer), or on demand, by the card bearer, and allows through the display to keep the bearer of the CCC current on his account status. In one embodiment of the present invention, we contemplate that airline companies issue such CCC to their passengers, or alternatively, create partnerships with credit card issuers that issue such CCC to their customers. In both cases, the wireless communication and the display features unique to the CCC, would enable constant updating of the passenger's air-miles current credit and make it readable at any time by the passenger on its CCC. In operation, the CCC can interface with the entertainment console in the same manner as other magnetic media (since the CCC also has a magnetic strip like any standard credit card), by providing the console with the passenger unique identification.

In yet another embodiment of the invention, the airliners issue dedicated Communicating Air-miles Cards (CAC) to a plurality of their passengers, and install at strategic locations within the airport, short range transceivers, tuned at the frequency of the CAC's receiver. These have the same structural and functional capabilities as the CCC mentioned above, except that their transceivers are dedicated to operate only in conjunction with the airport short range transceivers cited above. The communication protocol could for instance be a variant of the “Bluetooth” protocol, and when a passenger desires to update his cards, he moves to close proximity (typically less than ten feet), to one of said strategically located airline transceivers, pushes a “receive” button on his CAC, and, as a result, a short message is sent to said airline transceiver, that includes the passenger's unique ID within the airline's DBS. That causes said transceiver to respond with a message containing an update of the passenger's air-miles credit. Obviously, the message transmitted by the airline's transceiver contains a code (for instance, utilizing the passenger's unique ID) that assure that only the CAC with said ID can decode and store the data transmitted. When using a CAC as the means of updating air-miles to a customer, the same CAC is also used to activate the entertainment console on the airplane, via a similar short range transceiver in said console. Clearly, an additional key marked, for instance “play” can be used to activate said console, by a short message transmission form the CAC to the console. Once the console is activated, the passenger can put back the CAC in his wallet, and the console, according to its own schedule will update the CAC on the then current status of his air-miles credit. Obviously, the passenger may terminate any wagering session by an on/off switch on the console, and if he then desires to resume a new wagering session, he would activate the console again, with his CAC.

Another aspect of the present invention involves methods by which air-miles issued by different issuers can be used to settle in-flight wagering sessions, even though the carrier on which said wagering session occurs and the issuer of said air-miles are not the same.

Specifically, the method of doing business of the present invention, resulting in attrition of air-miles in passengers accounts, said air-miles being issued to said passengers by a plurality of issuers consists of:

having a plurality of issuers of air-miles credit to a plurality of air travelers, said issuers being one or more of, airline companies, hotel chains companies, car rental companies and other travel industry organization, in association with products and services acquired by said travelers from said issuers;

each of the air-miles issuing organizations maintaining for each passenger an account of its accrued air-miles credits, and communicating said credits to other air-miles issuing organizations;

negotiating between the various air-miles issuers and the in-flight gaming providers a prorating coefficient to determine the distribution of air-miles debits or credits resulting from in-flight gaming by passengers;

providing entertainment consoles that are gaming capable at a plurality of seats on a plurality of flights;

providing each qualified passenger means to engage in wagering during flights, including means that update each gaming console, or station with the then current accrued air-miles credit in each of the passenger various air-miles accounts;

displaying for said passenger the then current air-miles credited to his account, including additions or subtractions to said account resulting from the most recent gaming session engaged in by said passenger, and

allowing said passengers to engage in in-flight gaming and prorating air-miles attrition or additions resulting from said gaming between air-miles issuers and providers of in-flight gaming according the rates negotiated in c above.

It should be clear to a person trained in the art, that to the extent airlines may want to engage in swap attrition of air-miles, they can simply enable their corporate DBS, 32, as well as the specific CPU on each departing airplane, 30, to accept air-miles cards from swapping airline companies, using intermittent updating of air-miles information in passengers' accounts through linking to corporate partners DBS 34. Similarly, when using CCC as the medium of interface between an in-flight entertainment console and the passenger, any of the various air-miles credit such a passenger might possess, might be displayable on the CCC display, and to the extent that swap attrition is engaged in, the passenger, through the console interface, can select which of his air-miles credit he would be using in the in-flight wagering session.

While in the present disclosure we have described the use of air-miles for in-flight gaming and wagering, it should be understood that casino games represent only one form of gaming. In the future there is an expectation that airlines will make available to their passengers football, basketball, baseball and hockey games for viewing as well as wagering. The same would apply to wagers on other sporting events as well as dog and horse racing and the outcome of any potential competitions or races, including various political races.

The above description of methods of attrition of air-miles as well as various means of updating air-miles accounts and interfacing between the passenger and the entertainment consoles has been provided to illustrate preferred embodiment of the invention. It should be recognized that departures ma be made therefrom within the scope of the invention, as defined by the appended claims and equivalents thereof. Obvious modifications will become apparent to those of ordinary skills in the art.

We claim:

1. A method of processing passenger air-mile accounts to promote attrition thereof, comprising the steps of:
(a) issuing air-mile credits to passengers for embarking upon or completing air-line flights or as premiums for other activities or for purchases;
(b) maintaining for each passenger an account of accrued air-miles; and
(c) enabling a passenger having a respective account of accrued air-miles to engage in wagering upon a gaming console on a respective flight with gaming credits in the form of air-miles from the respective account and automatically in response to the wagering,
crediting winnings in terms of air-miles to the account of said passenger,
debiting losings in terms of air-miles to the account of said passenger, and
displaying additions to, subtractions from and current balances of air-miles in said account on said console.

2. The method defined in claim 1 wherein said console provides said passenger with access to a number of accounts maintained by a plurality of providers of goods and services, said method further comprising the steps of:
(d) automatically calculating prorating of air-mile credits and debits with respect to each of the accounts of the passenger based upon prior negotiations by the providers;
(e) enabling the passenger to draw selectively upon the passenger's accounts with said providers for the wagering upon said gaming console; and
(f) automatically crediting or debiting based upon the prorating of step (d) the selected account of the passenger with winnings or losings in step (c).

3. The method defined in claim 2 wherein a plurality of said gaming consoles are provided on each of a multiplicity of flights of an airline providing said air-miles.

4. The method defined in claim 3 wherein said gaming consoles are also provided at a waiting facility for a traveler.

5. The method defined in claim 2 wherein air-miles are provided to said passenger by recording an air-mile credit on a card held in possession of said passenger, said gaming console interacting with said card, air-miles recorded on said card being debited from said account upon a wagering loss and being credited to said account upon a wagering win.

6. The method defined in claim 2 wherein said account is maintained at a central station and is credited and debited through wireless communication with said gaming console.

7. The method defined in claim 2, further comprising assigning an account number to said player, said player activating said gaming console by inputting said account number thereto.

8. The method defined in claim 7 wherein said account number is recorded on a card assigned to said player and said gaming console has a card reader for reading said card and automatically responding to the recorded account number.

9. The method defined in claim 1 wherein said account is at least in part recorded on and updated on a card.

10. The method defined in claim 9 wherein said card is updated by wireless communication with a central station.

11. The method defined in claim 1 wherein said gaming console is accessed by a card issued to said passenger.

12. The method defined in claim 11 wherein said card is provided by an airline as a disposable card.

13. The method defined in claim 1, further comprising the steps of accumulating data with respect to wagering activity from a multiplicity of gaming consoles on an aircraft with a central processing unit thereon and communicating information with respect to the accounts of respective passengers from said central processing unit to a central ground computer installation of the airline.

14. The method defined in claim 1 wherein said console is one of a plurality of gaming consoles provided on a multiplicity of aircraft and at a plurality of locations in an airport, passenger accounts are accessed through wireless communication cards issued to the respective passengers, and said cards have displays which are updated intermittently automatically or on demand by the respective passengers.

15. The method defined in claim 14, further comprising the step of communicating with said cards through short-range transceivers provided in said airport.

16. The method defined in claim 1, further comprising the step of issuing said passenger a boarding pass for a flight and recording on said boarding pass an air-mile credit adapted to be used in said gaming console.

17. The method defined in claim 16 wherein said boarding pass is provided with a magnetic strip in which said air-mile credit is recorded, said method further comprising the step of updating the air-mile credit recorded in said magnetic strip based upon the wagering at said gaming console.
